(19) United States
(12) Patent Application Publication
(10) Pub. No.: US 2019/0185085 A1
(43) Pub. Date: Jun. 20, 2019

(54) MODULAR PRODUCTION LINE SYSTEM AND METHOD

(71) Applicant: Hirotec America, Inc., Auburn Hills, MI (US)

(72) Inventors: James B. Toeniskoetter, Rochester Hills, MI (US); Kyusang Yun, West Bloomfield, MI (US)

(21) Appl. No.: 16/170,146

(22) Filed: Oct. 25, 2018

Related U.S. Application Data
(60) Provisional application No. 62/584,252, filed on Nov. 10, 2017.

(51) Int. Cl. B62D 65/02; B23K 26/22; B23P 21/00; B21D 39/02

(52) U.S. Cl. CPC B62D 65/022; B23K 26/22; B23K 2101/006; B21D 39/023; B23P 21/004

(57) ABSTRACT

A modular production system and method includes an endless transport path defining a loop. A plurality of work cells in which processes are performed on a workplace are disposed in a sequence along the transport path. The work cells include an inner spot welding cell, an inner remote laser welding cell, and an outer roller flanging and laser welding cell. A transporter follows the transport path and selectively transfers the workplace between the work cells along the transport path. The transporter selects at least some of the work cells and makes a stop at the selected work cells, and the transporter bypasses any unselected work cells.

### CROSS REFERENCE TO RELATED APPLICATION

This application claims the priority of U.S. Provisional Application No. 62/584,252 filed Nov. 10, 2017.

### TECHNICAL FIELD

This invention relates to automotive closure manufacturing, and more particularly to vehicle body closure panel production.

### BACKGROUND OF THE INVENTION

As shown by example in FIG. 1, it is known in the art relating to automotive closure manufacturing that a production line process for production of parts for multiple vehicle models (e.g., five models) is built at its inception to accommodate all of the models. The required floor space and necessary equipment must be reserved and provided in the production facility in the beginning in order to be able to produce a sufficient amount of parts needed for all five models. In other words, the production line is configured to produce the total jobs per hour (JPH) for all five models combined, even if any or all of the second, third, fourth, or fifth models are to be introduced at a later date from the first model. Since all of the equipment is provided at inception of the production line, the technology that can foe introduced to the line is limited to the technology available at the time of inception of the first model. Also, at inception the footprint (area or floor space) of the production line is a maximum for the total number of models to be produced, even if some of the models will not be produced until a later date.

### SUMMARY OF THE INVENTION

The present invention provides a modular, flexible, multi-model production line system and method that can add additional product/models to the line over time without the need to reserve production facility floor space and production equipment in advance. The modular production line can be expanded to support required production volumes of added product models without the need for the required equipment to be present at the inception of the line. Also, future products and/or models can be added to the flexible, modular production system even if the future products are distinct from the existing products/models produced in the line, and new production methods and technology may be added to the system at any time. The modular production line system and method thereby allows for flexible production of multiple parts in a single line and for the introduction of future models and technology into an existing production line.

More particularly, a modular production system in accordance with the invention includes an endless transport path defining a loop. A plurality of work cells, in which forming processes such as shaping, joining, and similar are performed on a workplace, are disposed in a sequence along the transport path. The work cells include an inner spot welding cell, an inner remote laser welding cell, and an outer roller flanging and laser welding cell. A transporter follows the transport path and selectively transfers the workpiece between the work cells along the transport path. A controller controls the transporter along the transport path, whereby the transporter selects at some of the work cells and makes a stop at the selected work cells, and the transporter bypasses any unselected work cells.

The inner spot welding cell may include a panel fixture and a spot welding device that performs inner spot welding of workpieces on the panel fixture. The inner spot welding cell may also include additional panel fixtures.

The inner remote laser welding cell may include a panel fixture and a laser welding device. The inner remote laser welding cell may also include additional panel fixtures. The inner remote laser welding cell may further include additional laser welding devices.

The outer roller flanging and laser welding cell may include panel fixtures, roller flanging devices, laser welding devices, and container towers and/or storage racks that store finished workplaces. The outer roller flanging and laser welding cell may also include additional panel fixtures, container towers, and/or storage racks.

An additional work cell may be added along the transport path.

The workpiece may be a vehicle body closure panel. The workpiece may be moved from the transporter into one of the selected work cells, and the workpiece may be moved back to the transporter after being worked on in the selected work cell.

The system may also include a plurality of multi-axis robots each including an arm. The robots move the workpiece to and from the transporter and move the workpiece within the work cells.

In another arrangement, a modular production line system in accordance with the invention includes an endless transport path defining a loop. A plurality of work cells in which forming processes are performed on vehicle body closure panels are disposed in a sequence along the transport path. A transporter follows the transport path and selectively transfers the workplace between the work cells along the transport path. A controller controls the transporter along the transport path, whereby the transporter selects at least some of the work cells and makes a stop at the selected work cells, and the transporter bypasses any unselected work cells.

A method of manufacturing vehicle body closure panels in accordance with the invention includes the steps of selectively transferring a workpiece between a plurality of work cells disposed in a sequence along an endless transport path defining a loop, the work cells including an inner spot welding cell, an inner remote laser welding cell, and an outer roller flanging and laser welding cell, by providing a transporter that follows the transport path and moves the workpiece between the work cells along the transport path, and a controller that controls the transporter along the transport path, wherein the transporter selects at least some of the work cells, and makes a stop at the selected work cells, and the transporter bypasses any unselected work cells; and performing at least one of inner spot welding the workpiece in the inner spot welding cell, laser welding the workpiece in the inner remote laser welding cell, and roller flanging and laser welding the workpiece in the outer roller flanging and laser welding cell. At least some of the work cells along the transport path are selected and utilized, and any unselected work cells are bypassed.

The controller may cause the workpiece to be moved into and out of the selected work cells, and the controller may cause the workpiece to be moved past any unselected work cells. The method may further include multi-axis robots controlled by the controller, wherein the multi-axis robots move the workpiece into, out of, and within the selected work cells.

The method may further include the step of adding an additional work cell along the transport path. The method may also include the step of adding additional equipment to at least one of the work cells.

More than one type of finished part may be produced from the workpieces by selectively choosing work cells among the plurality of work cells and/or by selectively choosing to utilize certain processes within the work cells.

These and other features and advantages of the invention will be more fully understood from the following detailed description of the invention taken together with the accompanying drawings.

### BRIEF DESCRIPTION OF THE DRAWINGS

In the drawings:

FIG. 1 is a plan view of a prior art production line;

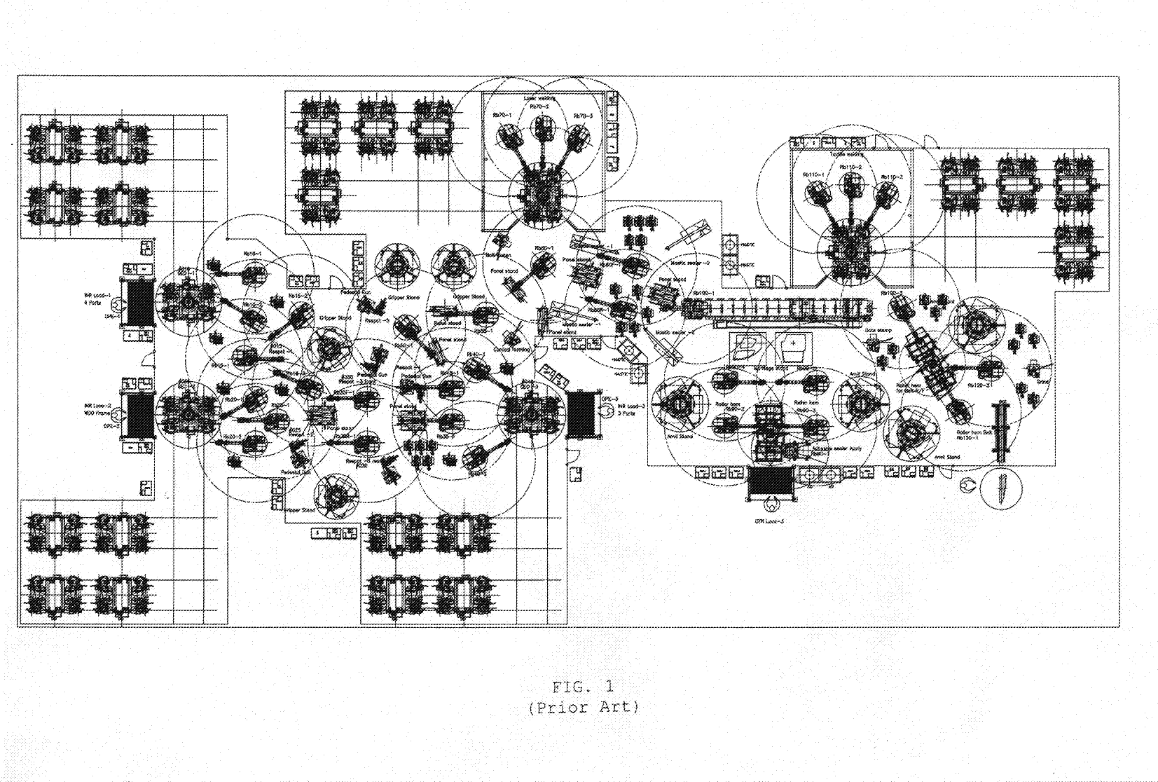

FIG. 2 is a plan view of a modular, flexible production line system and method in accordance with the invention producing a single model;

FIG. 3 is a plan view of the modular production line system and method further incorporating production of a second model into the line;

FIG. 4 is a plan view of the modular production line system and method further incorporating production of a third model into the line;

FIG. 5 is a plan view of the modular production line system and method further incorporating production of a fourth model into the line;

FIG. 6 is a plan view of the modular production line system and method further incorporating production of a fifth model into the line;

FIG. 7 is a flowchart of a method of producing a single model in the system shown in FIG. 2;

FIG. 8 is a flowchart of a method of producing a second model in the system shown in FIG. 3;

FIG. 9 is a flowchart of a method of producing a third model in the system shown in FIG. 4;

FIG. 10 is a flowchart of a method of producing a fourth model in the system shown in FIG. 5;

FIG. 11 is a flowchart of a method of producing a fifth model in the system shown in FIG. 6; and

FIG. 12 is a flowchart of a production line method in accordance with the invention.

### DETAILED DESCRIPTION OF THE INVENTION

Referring now to the drawings in detail, the modular production system and method includes an endless transport path defining a production loop. A plurality of work cells, each for performing a certain forming process or processes on a workpiece such as a vehicle closure panel, are disposed along the transport path. The forming processes may generally include shaping, joining, and the like, such as welding, flanging, hemming, etc. A transporter, such as an automated guided vehicle (AGC/AGV) and associated tooling cart, transfers in-process workpieces between cells along the transport path. Each work, cell may include production equipment such as but not limited to multi-axis robots including arms, panel fixtures, turntables, storage racks, hemming devices, spot welding devices, laser welding devices, roller flanging devices, belt line hemming devices, impact beam assembly devices, and the like. A controller that may include a CPU or similar controls the transporter along the transport path. The same controller or an additional controller or controllers may control the multi-axis robots and other equipment in the work cells to affect and synchronize the flow of workpieces in and through the system. A plurality of different models of parts can be produced in the system by selecting and utilizing some or all of the cells along the transport path and/or bypassing other unselected cells along the path (i.e. “selectively transferring” the workpiece between the cells). Further, additional cells can be added along the transport path and/or additional equipment can be added to existing cells to support production of additional models.

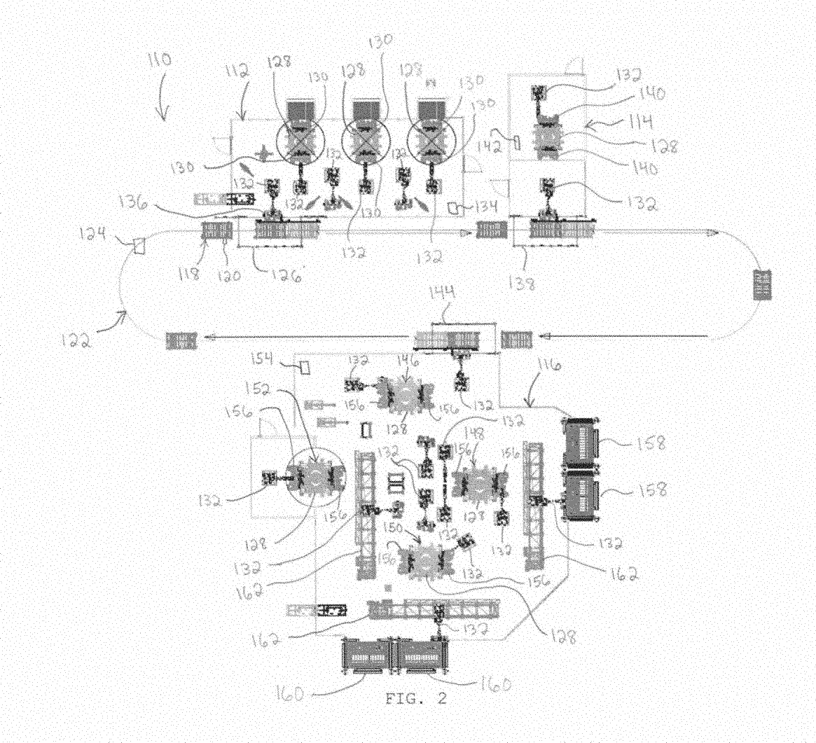

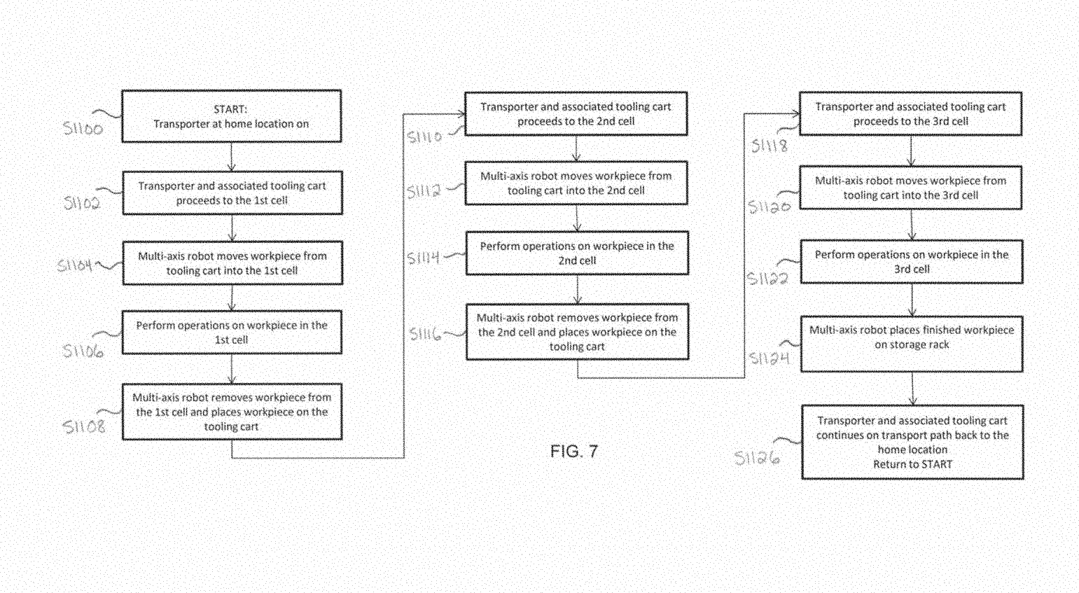

As shown fey example in FIGS. 2 and 7, the modular production line system 110 may at inception include a subset of work cells for producing a first vehicle closure panel model (model 1). The work cells may include, in sequential order, an inner spot welding cell 112, an inner remote laser welding cell 114, and an outer roller flanging and laser welding cell 116. In-process workplaces are transferred between cells using automated guided vehicles 118 and associated tooling carts that are controlled by a controller 120 and moved along an endless transport path 122 defining a production loop. The automated guided vehicle controlled by the controller begins the process at a home starting location 124 (step S1110), and at step S1102 the automated guided vehicle moves the tooling cart first from the home starting location 124 to a station 126 at the inner spot welding cell (first cell) 112 on the transport path. The inner spot welding cell includes a plurality of turntables 128, in this case three, each including a plurality of spot welding fixtures 130. The inner spot welding cell also includes a plurality of multi-axis robots 132 controlled by a controller 134. One of the robots loads and unloads workplaces from the tooling cart 118. Other robots move the workpieces to and from one or more spot welding fixtures 130 and/or perform inner spot welding on the workplaces that are placed in the spot welding fixtures. At step S1104, one of the robots unloads a workpiece 136 from the tooling cart and brings the workpiece into the inner spot welding cell for operations to be performed on the workpiece at the welding fixtures. Once inner spot welding of the workpiece is complete at step S1106, the robot loads the workpiece back onto the tooling cart at step S1108. At step S1110, the automated guided vehicle next moves the tooling cart along the transport path to a station 138 at the inner remote laser welding cell (second cell) 114. The inner remote laser welding cell includes a turntable 128 including a plurality of laser welding fixtures 140, and a plurality of multi-axis robots 132 controlled by a controller 142. One of the robots loads and unloads workplaces from the tooling cart, and another robot performs inner remote laser welding on the workplaces that are placed in the laser welding fixtures. At step S1112, the robot unloads the workpiece from the tooling cart, at step S1114 inner remote laser welding is performed on the workpiece in the cell, and at step S1116 the robot loads the workpiece back onto the tooling cart. At step S1118, the automated guided vehicle then transports the tooling cart along the transport path to a station 144 at the outer roller flanging and laser welding cell 116 (third cell). The outer roller flanging and laser welding cell includes a plurality of turntables 128, in this case four. One of the turntables is located at an impact beam assembly station 146 at which impact beam assembly is performed, another of the turntables is located at a roller flanging station 148 at which roller flanging is performed, another of the turntables is located at a belt line hemming station 150 at which belt line hemming is performed, and another of the turntables is located at a laser welding station 152 at which laser welding is performed. Each of the stations 146, 148, 150, 152 includes various fixtures 156. The outer roller flanging and laser welding cell also includes a plurality of multi-axis robots 132 controlled by a controller 154. One of the robots loads and unloads workplaces from the tooling cart, and other robots move the workplaces to and from stations in the cell and/or perform the operations (roller flanging, laser welding, and the like) on the workpieces. The outer roller flanging and laser welding cell further includes outer panel racks 158 that store outer panels to be joined with inner panels, and final assembly racks 160 that store finished, finally assembled workplaces. The cell may also include tracks 162 along which some of the robots 132 move in the cell. At step S1120, one of the robots unloads the workpiece from the tooling cart, at step S1122 processes such as roller flanging, laser welding and/or other operations are performed on the workpiece in the cell, and at step S1124 the finished workpiece is loaded onto one of the final assembly storage racks. At step S1126, the automated guided vehicle then continues along the transport path 122, returns to the home location 124, and begins the process again.

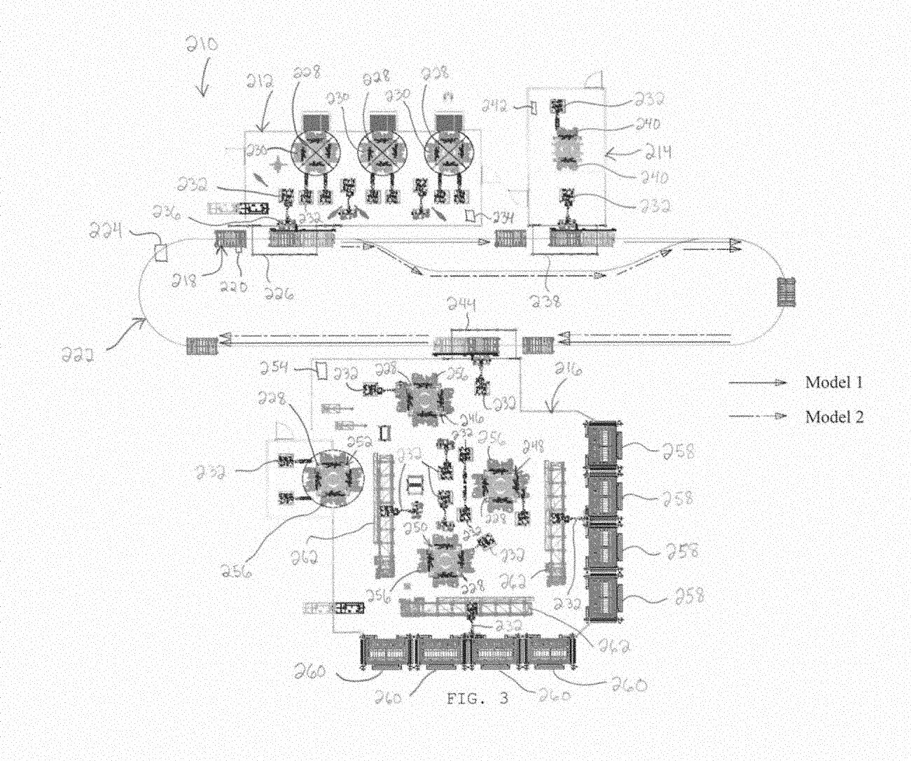

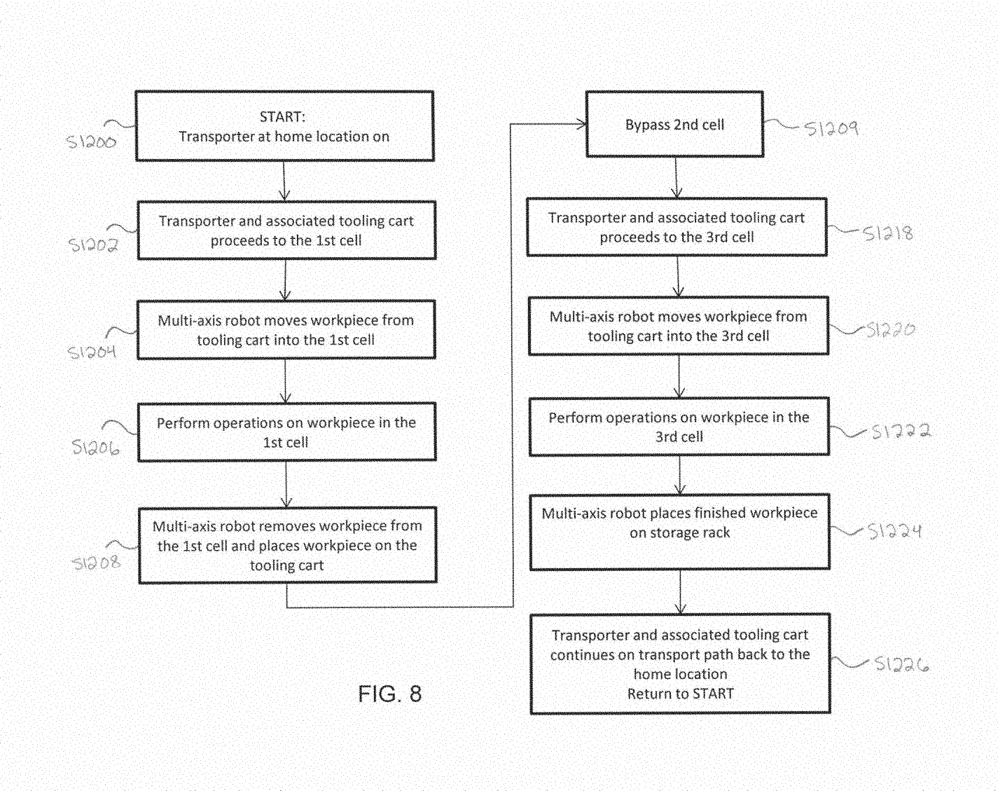

Turning to FIGS. 3 and 8, when a second model is later introduced into the modular production line 210 (like reference numerals in the drawings indicate the same or similar elements), the automated guided vehicle 218 may for example be configured to stop at certain cells and to bypass other cells for production of the second model (model 2 in FIG. 3). For example, the workplaces produced for the second model may only enter the inner spot welding cell 212 (first cell) and the outer roller flanging and laser welding cell 216 (third cell), and may bypass the inner remote laser welding cell 214 (second cell). Also, additional equipment may be added to the existing cells for production of the second model. For example, panel fixtures 230 and robots 232 may be added to the inner spot welding cell 212, and outer panel racks 258, final assembly storage racks 260 and/or panel fixtures 256 may be added to the outer roller flanging and laser welding cell 216. The inner spot welding cell 212 includes a plurality of turntables 228 each including a plurality of spot welding fixtures 230. The inner spot welding cell also includes a plurality of multi-axis robots 232 controlled by a controller 234. One of the robots loads and unloads workplaces from the tooling cart 218. Other robots move the workplaces to and from one or more spot welding fixtures 230 and/or perform inner spot welding on the workpieces that are placed in the spot welding fixtures. The inner remote laser welding cell 214 includes a turntable 228 including a plurality of laser welding fixtures 240, and a plurality of multi-axis robots 232 controlled by a controller 242. One of the robots loads and unloads workplaces from the tooling cart, and another robot performs inner remote laser welding on the workplaces that are placed in the laser welding fixtures. The outer roller flanging and laser welding cell 216 includes a plurality of turntables 228. One of the turntables is located at an impact beam assembly station 246 at which impact beam assembly is performed, another of the turntables is located at a roller flanging station 248 at which roller flanging is performed, another of the turntables is located at a belt line hemming station 250 at which belt line hemming is performed, and another of the turntables is located at a laser welding station 252 at which laser welding is performed. Each of the stations 246, 248, 250, 252 includes various fixtures 256. The outer roller flanging and laser welding cell also includes a plurality of multi-axis robots 232 controlled by a controller 254. One of the robots loads and tin loads workplaces from the tooling cart, and other robots move the workpieces to and from stations in the cell and/or perform the operations (roller flanging, laser welding, and the like) on the workpieces. The outer roller flanging and laser welding cell further includes outer panel racks 258 that store outer panels to be joined with inner panels, and final assembly racks 260 that store finished, finally assembled workpieces. The cell may also include tracks 262 along which some of the robots 232 move in the cell. At step S1200, the automated guided vehicle 218 begins the process at the home start location 224. At step S1202, the automated guided vehicle 218 controlled by the controller 220 moves the tooling cart along the transport path 222 first from the home starting location 224 to the station 226 at the inner spot welding cell (first cell) 212. At step S1204, one of the robots 232 unloads a workpiece 236 from the tooling cart and brings the workpiece into the inner spot welding cell for operations to be performed on the workpiece at the welding fixtures. Once inner spot welding of the workpiece is complete at step S1206, the robot loads the workpiece back onto the tooling cart at step S1208. At step S1209, the automated guided vehicle bypasses the inner remote laser welding cell (second cell) 214 and does not stop at the station 238 at the second cell. At step S1218, the automated guided vehicle then transports the tooling cart along the transport path to the station 244 at the outer roller flanging and laser welding cell 216 (third cell). At step S1220, one of the robots 232 unloads the workpiece from the tooling cart, at step S1222 roller flanging, laser welding and/or other operations are performed on the workpiece in the cell, and at step S1224 the finished workpiece is loaded onto one of the final assembly storage racks 260. At step S1226, the automated guided vehicle then continues along the transport path 222, returns to the home location 224, and begins the process again.

When a third and subsequent models are later introduced into the modular production line, new cells may be constructed and added to the line in order to accommodate the production volume (jobs per hour requirements) for the added models. Any additional floor space needed for the production line can be located anywhere in the production facility since the workpieces are transferred between cells by the automated guided vehicles. For each newly introduced model, the automated guided vehicle can be configured to stop at existing cell(s) if the process(es) performed at the cell(s) can be utilized for the new model, and/or the automated guided vehicle can be configured to travel to and stop at new cells as necessary. Since newly introduced models can use new cells, then new product types, constructions, and technology can be introduced into the production line.

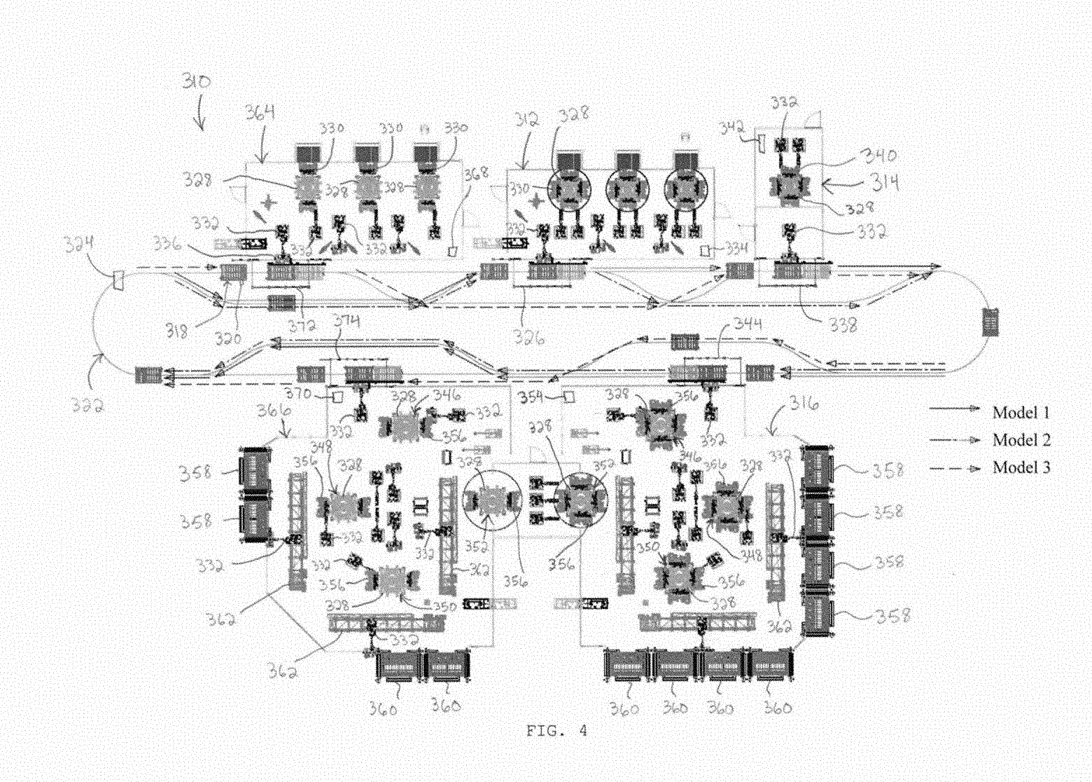

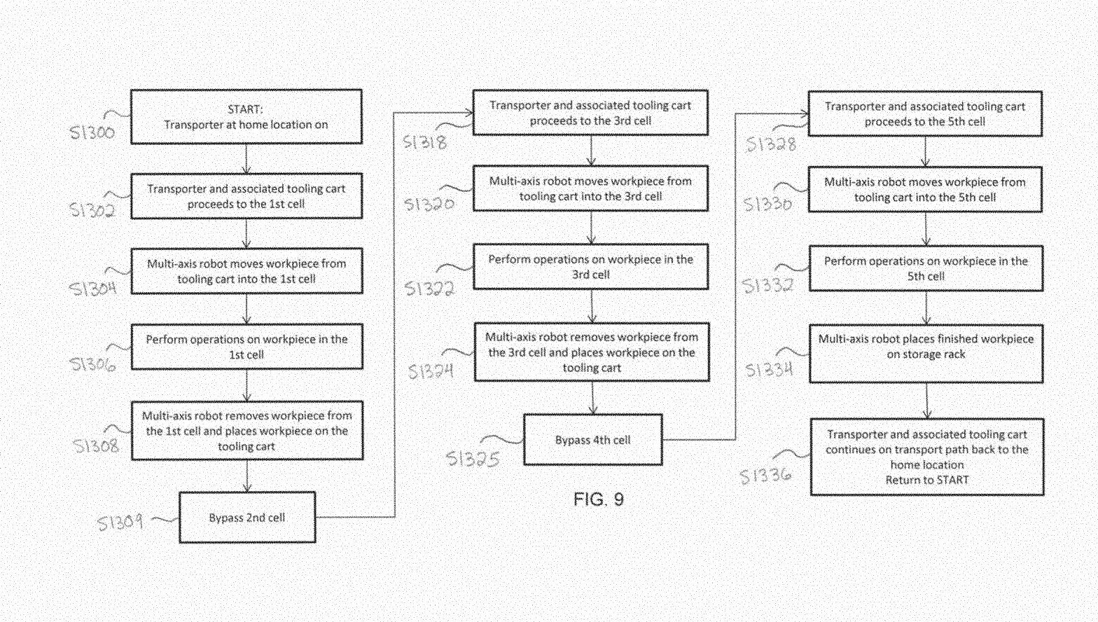

Specifically, as shown by example in FIGS. 4 and 9, when a third model (model 3 in FIG. 4) is introduced into the modular production line 310, a new inner spot welding cell 364 and a new outer roller flanging and laser welding cell 366 may be added to the production line. Also, new laser welding fixtures 340 may be added to the existing, original inner remote laser welding cell 314. The new inner spot welding cell 364 includes a plurality of turntables 328, in this case three, each including a plurality of spot welding fixtures 330. The new inner spot welding cell 364 also includes a plurality of robots 332 controlled by a controller 368. One of the robots loads and unloads workpieces from the tooling cart. Other robots move the workpieces to and from one or more spot welding fixtures 330 and/or perform inner spot welding on the workpieces that are placed in the spot welding fixtures. The new outer roller flanging and laser welding cell 366 includes a plurality of turntables 328, in this case four. One of the turntables is located at an impact beam assembly station 346 at which impact beam assembly is performed, another of the turntables is located at a roller flanging station 348 at which roller flanging is performed, another of the turntables is located at a belt line hemming station 350 at which belt line hemming is performed, and another of the turntables is located at a laser welding station 352 at which laser welding is performed. Each of the stations 346, 348, 350, 352 includes various fixtures 356. The new outer roller flanging and laser welding cell 366 also includes a plurality of robots 332 controlled by a controller 370. One of the robots loads and unloads workpieces from the tooling cart, and other robots move the workpieces to and from stations in the cell and/or perform the operations (roller flanging, laser welding, and the like) on the workpieces. The new outer roller flanging and laser welding cell 366 further includes outer panel racks 358 that store outer panels to be joined with the inner panel workpieces, and final assembly racks 360 that store finished, finally assembled workpieces. The cell may also include tracks 362 along which some of the robots move in the cell. The existing, original inner spot welding cell 312 includes a plurality of turntables 328 each including a plurality of spot welding fixtures 330. The inner spot welding cell 312 also includes a plurality of multi-axis robots 332 controlled by a controller 334. One of the robots loads and unloads workpieces from the tooling cart 318. Other robots move the workpieces to and from one or more spot welding fixtures 330 and/or perform inner spot welding on the workpieces that are placed in the spot welding fixtures. The existing, original remote laser welding cell 314 includes a turntable 328 including a plurality of laser welding fixtures 340, and a plurality of multi-axis robots 332 controlled by a controller 342. One of the robots loads and unloads workpieces from the tooling cart, and another robot performs inner remote laser welding on the workpieces that are placed in the laser welding fixtures. The existing, original outer roller flanging and laser welding cell 316 includes a plurality of turntables 328. One of the turntables is located at an impact beam assembly station 346 at which impact beam assembly is performed, another of the turntables is located at a roller flanging station 348 at which roller flanging is performed, another of the turntables is located at a belt line hemming station 350 at which belt line hemming is performed, and another of the turntables is located at a laser welding station 352 at which laser welding is performed. Each of the stations 346, 348, 350, 352 includes various fixtures 356. The outer roller flanging and laser welding cell 316 also includes a plurality of multi-axis robots 332 controlled by a controller 354. One of the robots loads and unloads workplaces from the tooling cart, end other robots move the workplaces to and from stations in the cell and/or perform the operations (roller flanging, laser welding, and the like) on the workplaces. The outer roller flanging and laser welding cell 316 further includes outer panel racks 358 that store outer panels to be joined with inner panels, and final assembly racks 360 that store finished, finally assembled workplaces. The cell may also include tracks 362 along which some of the robots 332 move in the cell. The process begins at the home starting location 324 (S1300). From the home starting location, at stop S1302 the automated guided vehicle 318 controlled by the controller 320 moves the tooling cart first front the home starting location and stops at a station 372 at the new inner spot welding cell (first cell) 364. At step S1304, a robot 332 unloads a workpiece 336 from the tooling cart and brings the workpiece into the new inner spot welding cell. Once inner spot welding of the workpiece is complete at step S1306, the robot loads the workpiece back onto the tooling cart at step S1308. Next, the automated guided vehicle bypasses the station 326 at the original inner spot welding cell (second cell) 312 at step S1309, and proceeds to and stops at the station 338 at the inner remote laser welding cell (third cell) 314 at step S1318. At step S1320, a robot 332 unloads the workpiece from the tooling cart, at step S1322 inner remote laser welding is performed on the workpiece in the cell, and at step S1324 the robot controlled by the controller loads the workpiece back onto the tooling cart. At step S1325, the automated guided vehicle bypasses the station 344 at the original outer roller flanging and laser welding cell (fourth cell) 316, and proceeds along the transport path and at step S1328 stops at a station 374 at the new outer roller flanging and laser welding cell (fifth cell) 366. At step S1330, a robot 332 controlled by the controller unloads the workpiece from the tooling cart, at step S1332 roller flanging, laser welding and/or other operations are performed on the workpiece in the cell, and at step S1334 the finished workpiece is loaded onto one of the storage racks 360. At step S1336, the automated guided vehicle then continues along the transport path 322, returns to the home location 324, and begins the process again.

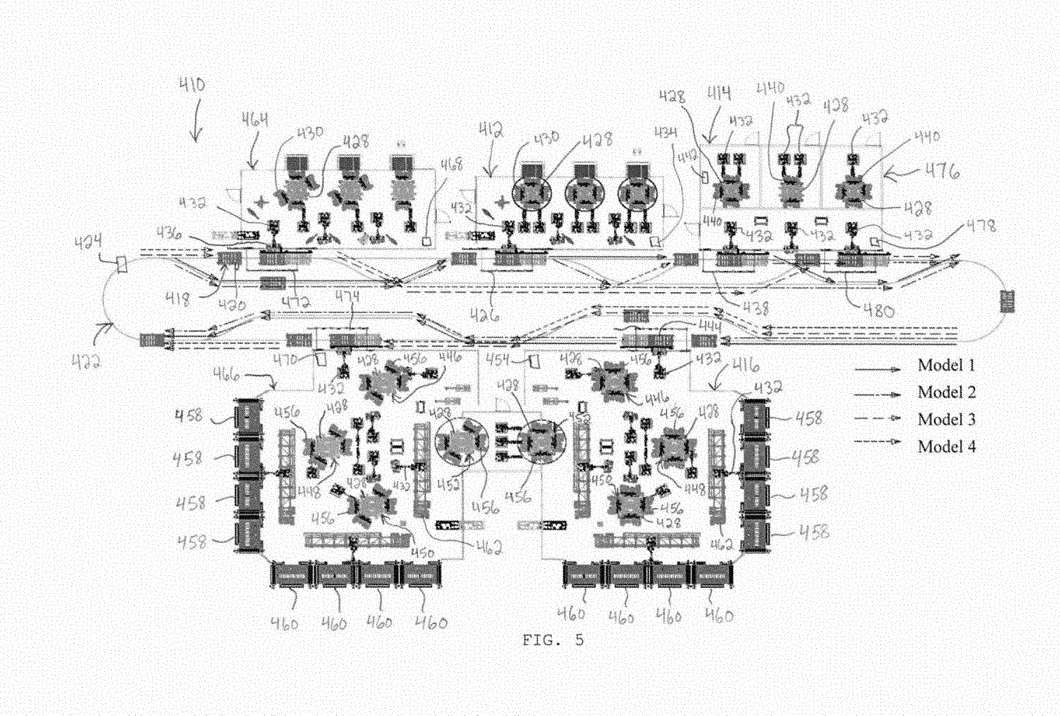

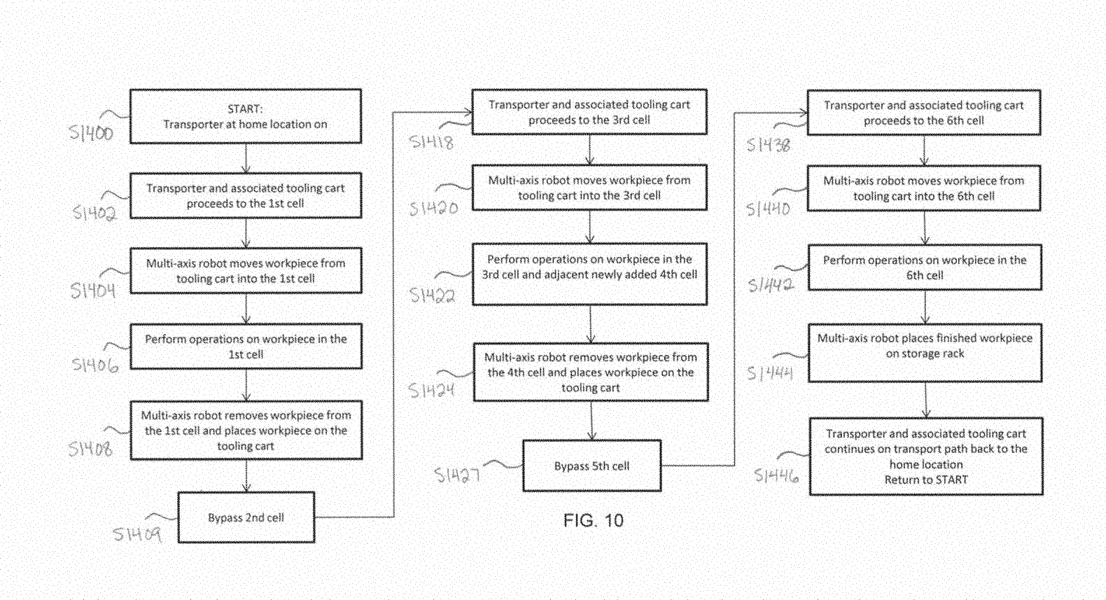

Turning to FIGS. 5 and 10, when a fourth model (model 4 in FIG. 5) is introduced into the modular production line 410, a new inner remote laser welding cell 476 may be added to the production line. The new inner remote laser welding cell includes turntables 428 each including a plurality of laser welding fixtures 440, and a plurality of robots 432 controlled by a controller 478. One of the robots loads and unloads workpieces from the tooling cart, other robots perform inner remote laser welding on the workpieces that are placed in the laser welding fixtures, and one of the robots may move workpieces within the cell. Also, in the production line 410, new panel fixtures 430 may be added to the existing (added) inner spot welding cell 464 and the existing (added) outer roller flanging and laser welding cell 466, and new storage racks 358, 360 may be added to the existing (added) outer roller flanging and laser welding cell 466. The existing, original inner spot welding cell 412 includes a plurality of turntables 428 each including a plurality of spot welding fixtures 430. The inner spot welding cell 412 also includes a plurality of multi-axis robots 432 controlled by a controller 434. One of the robots loads and unloads workpieces from the tooling cart 418. Other robots move the workpieces to and from one or more spot welding fixtures 430 and/or perform inner spot welding on the workpieces that are placed in the spot welding fixtures. The added inner spot welding cell 464 includes a plurality of turntables 428 each including a plurality of spot welding fixtures 430. The added inner spot welding cell 464 also includes a plurality of robots 432 controlled by a controller 468. One of the robots loads and unloads workpieces from the tooling cart. Other robots move the workpieces to and from one or more spot welding fixtures 430 and/or perform inner spot welding on the workpieces that are placed in the spot welding fixtures. The existing, original remote laser welding cell 414 includes a turntable 428 including a plurality of laser welding fixtures 440, and a plurality of multi-axis robots 432 controlled by a controller 442. One of the robots loads and unloads workpieces from the tooling cart, and another robot performs inner remote laser welding on the workpieces that are placed in the laser welding fixtures. The existing, original outer roller flanging and laser welding cell 416 includes a plurality of turntables 428. One of the turntables is located at an impact beam assembly station 446 at which impact beam assembly is performed, another of the turntables is located at a roller flanging station 448 at which roller flanging is performed, another of the turntables is located at a belt line hemming station 450 at which belt line hemming is performed, and another of the turntables is located at a laser welding station 452 at which laser welding is performed. Each of the stations 446, 448, 450, 452 includes various fixtures 456. The outer roller flanging and laser welding cell 416 also includes a plurality of multi-axis robots 432 controlled by a controller 454. One of the robots loads and unloads workpieces from the tooling cart, and other robots move the workpieces to and from stations in the cell and/or perform the operations (roller flanging, laser welding, and the like) on the workpieces. The outer roller flanging and laser welding cell 416 further includes outer panel racks 458 that store outer panels to be joined with inner panels, and final assembly racks 460 that store finished, finally assembled workpieces. The cell may also include tracks 462 along which some of the robots 432 move in the cell. The added inner spot welding cell 464 includes a plurality of turntables 428 each including a plurality of spot welding fixtures 430. The added inner spot welding cell 464 also includes a plurality of robots 432 controlled by a controller 468. One of the robots loads and unloads workpieces from the tooling cart. Other robots move the workpieces to and from one or more spot welding fixtures 430 and/or perform inner spot welding on the workpieces that are placed in the spot welding fixtures. The added outer roller flanging and laser welding cell 466 includes a plurality of turntables 428. One of the turntables is located at an impact beam assembly station 446 at which impact beam assembly is performed, another of the turntables is located at a roller flanging station 448 at which roller flanging is performed, another of the turntables is located at a belt line hemming station 450 at which belt line hemming is performed, and another of the turntables is located at a laser welding station 452 at which laser welding is performed. Each of the stations 446, 448, 450, 452 includes various fixtures 456. The added outer roller flanging and laser welding cell 466 also includes a plurality of robots 432 controlled by a controller 470. One of the robots loads and unloads workplaces from the tooling cart, and other robots move the workpieces to and from stations in the cell and/or perform the operations (roller flanging, laser welding, and the like) on the workpieces. The added outer roller flanging and laser welding cell 466 further includes outer panel racks 458 that store outer panels to be joined with the inner panel workpieces, and final assembly racks 460 that store finished, finally assembled workpieces. The cell may also include tracks 462 along which some of the robots move in the cell. From the home starting location 424 at step S1400, the automated guided vehicle 418 controlled by the controller 420 moves the tooling cart first from the home starting location 424 along the transport path 422 and stops at a station 472 at the previously added inner spot welding cell (first cell) 464 at step S1402. At step S1404, a robot 432 unloads a workpiece 436 from the tooling cart and brings the workpiece into the inner spot welding cell 464. Once inner spot welding of the workpiece is complete at step S1406, the robot loads the workpiece back onto the tooling cart at step S1408. Next, the automated guided vehicle bypasses the station 426 at the original inner spot welding cell (second cell) 412 at step S1409, and at step S1418 proceeds to and stops at the stations 438, 480 at the original inner remote laser welding cell and the new inner remote laser welding cell (third and fourth cells) 414, 476. At step S1420, a robot 432 unloads the workpiece from the tooling cart, at step S1422 inner remote laser welding is performed on the workpiece in the cells, and at step S1424 a robot 432 loads the workpiece back onto the tooling cart. At step S1427, the automated guided vehicle bypasses the station 444 at the original outer roller flanging and laser welding cell (fifth cell) 416, and at step S1438 proceeds along the transport path and stops at a station 474 at the previously added outer roller flanging and laser welding cell (sixth cell) 466. At step S1440, a robot 432 unloads the workpiece from the tooling cart, at step S1442 roller flanging, laser welding and/or other operations are performed on the workpiece in the cell, and at step S1444 the finished workpiece is loaded onto one of the storage racks 460. At step S1446, the automated guided vehicle then continues along the transport path 422, returns to the home location 424, and begins the process again.

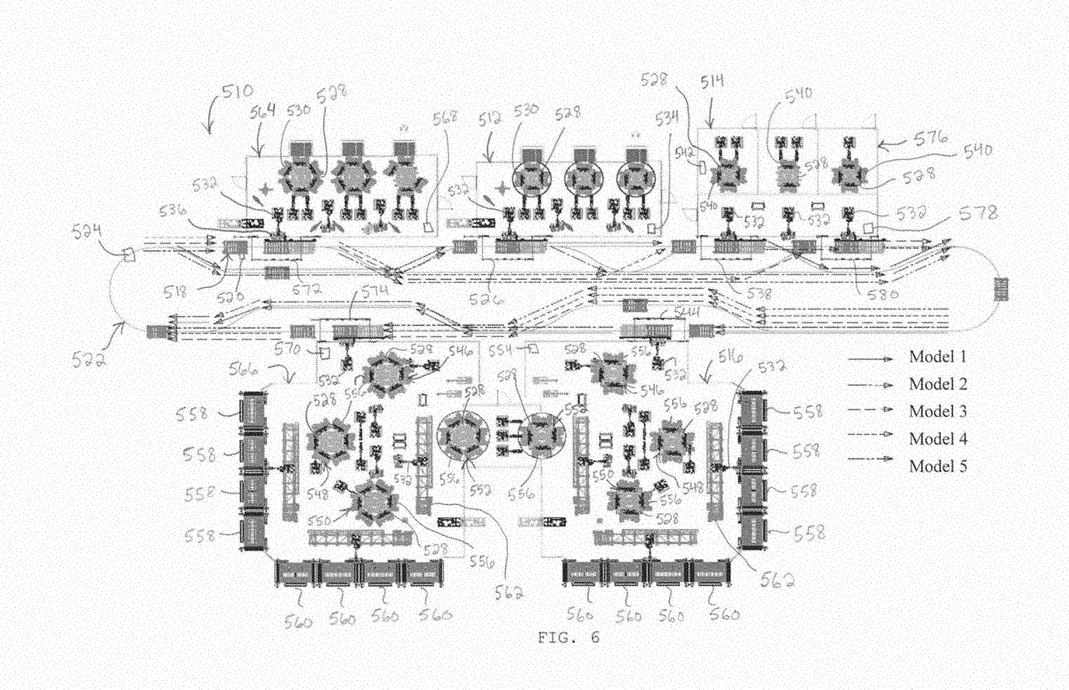

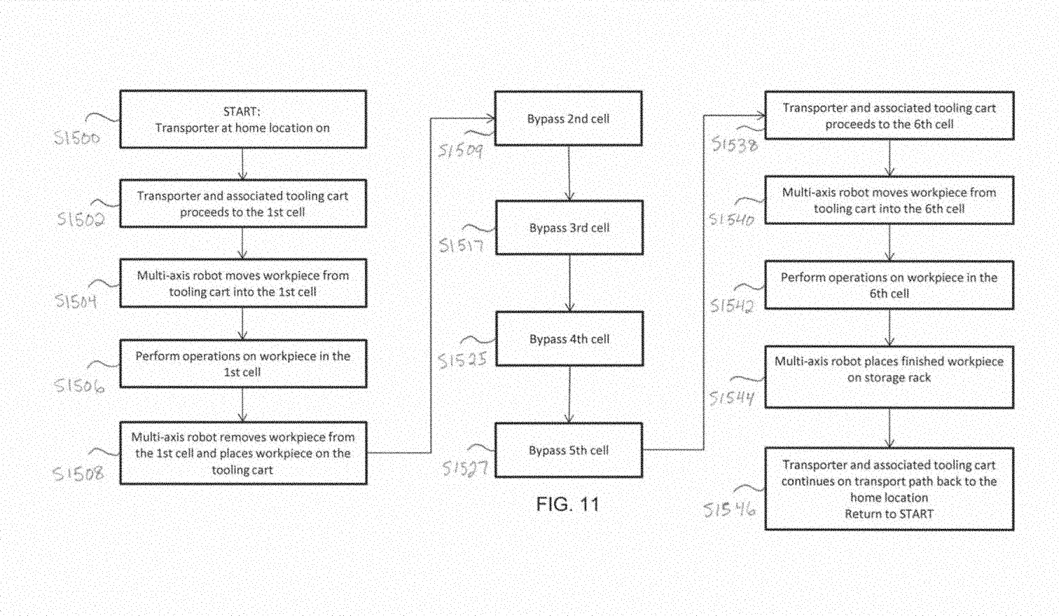

Turning to FIGS. 6 and 11, when a fifth model (model 5 in FIG. 6) is introduced into the modular production line 510, new panel fixtures 530 may be added to the existing (added) inner spot welding cell 564 and new panel fixtures 556 may be added to the existing (added) outer roller flanging and laser welding cell 566. The original inner spot welding cell 512 includes a plurality of turntables 528 each including a plurality of spot welding fixtures 530. The original inner spot welding cell 512 also includes a plurality of multi-axis robots 532 controlled by a controller 534. One of the robots loads and unloads workpieces from the tooling cart 518. Other robots move the workpieces to and from one or more spot welding fixtures 530 and/or perform inner spot welding on the workpieces that are placed in the spot welding fixtures. The added inner spot welding cell 564 includes a plurality of turntables 528 each including a plurality of spot welding fixtures 530. The added inner spot welding cell 564 also includes a plurality of robots 532 controlled by a controller 568. One of the robots loads and unloads workpieces from the tooling cart. Other robots move the workpieces to and from one or more spot welding fixtures 530 and/or perform inner spot welding on the workpieces that are placed in the spot welding fixtures. The original remote laser welding cell 514 includes a turntable 528 including a plurality of laser welding fixtures 540, and a plurality of multi-axis robots 532 controlled by a controller 542. One of the robots loads and unloads workpieces from the tooling cart, and other robots perform inner remote laser welding on the workpieces that are placed in the laser welding fixtures. The added inner remote laser welding cell 576 includes turntables 528 each including a plurality of laser welding fixtures 540, and a plurality of robots 532 controlled by a controller 578. One of the robots loads and unloads workpieces from the tooling cart, other robots perform inner remote laser welding on the workpieces that are placed in the laser welding fixtures, and one of the robots may move workpieces within the cell. The original outer roller flanging and laser welding cell 516 includes a plurality of turntables 528. One of the turntables is located at an impact beam assembly station 546 at which impact beam assembly is performed, another of the turntables is located at a roller flanging station 548 at which roller flanging is performed, another of the turntables is located at a belt line hemming station 550 at which belt line hemming is performed, and another of the turntables is located at a laser welding station 552 at which laser welding is performed. Each of the stations 546, 548, 550, 552 includes various fixtures 556. The original outer roller flanging and laser welding cell 516 also includes a plurality of multi-axis robots 532 controlled by a controller 554. One of the robots loads and unloads workpieces from the tooling cart, and other robots move the workpieces to and from stations in the cell and/or perform the operations (roller flanging, laser welding, and the like) on the workpieces. The original outer roller flanging and laser welding cell 516 further includes outer panel racks 558 that store outer panels to be joined with inner panels, and final assembly racks 560 that store finished, finally assembled workpieces. The cell may also include tracks 562 along which some of the robots 532 move in the cell. The added outer roller flanging and laser welding cell 566 includes a plurality of turntables 528. One of the turntables is located at an impact beam assembly station 546 at which impact beam assembly is performed, another of the turntables is located at a roller flanging station 548 at which roller flanging is performed, another of the turntables is located at a belt line hemming station 550 at which belt line hemming is performed, and another of the turntables is located at a laser welding station 552 at which laser welding is performed. Each of the stations 546, 548, 550, 552 includes various fixtures 556. The added outer roller flanging and laser welding cell 566 also includes a plurality of robots 532 controlled by a controller 570. One of the robots loads and unloads workpieces from the tooling cart, and other robots move the workpieces to and from stations in the cell and/or perform the operations (roller flanging, laser welding, and the like) on the workpieces. The added outer roller flanging and laser welding cell 566 further includes outer panel racks 558 that store outer panels to be joined with the inner panel workpieces, and final assembly racks 560 that store finished, finally assembled workpieces. The cell may also include tracks 562 along which some of the robots move in the cell. From the home starting location 524 at step S1500, the automated guided vehicle 518 controlled by the controller 520 moves the tooling cart first from the home starting location along the transport path 522 and at step S1502 stops at a station 572 at the previously added inner spot welding cell (first cell) 564. At step S1504, a robot 532 unloads a workpiece from the tooling cart and brings the workpiece into the inner spot welding cell 564. Once inner spot welding of the workpiece is complete at step S1506, the robot loads the workpiece back onto the tooling cart at step S1508. Next, the automated guided vehicle bypasses the station 526 at the original inner spot welding cell (second cell) 512 at step S1509, bypasses the station 538 at the original inner remote laser welding cell (third cell) 514 at step S1517, bypasses the station 580 at the previously added inner remote laser welding cell (fourth cell) 576 at step S1525, bypasses the station 544 at the original outer roller flanging and laser welding cell (fifth cell) 516 at step S1527, and at step S1538 stops at the station 574 at the previously added outer roller flanging and laser welding cell (sixth cell) 566. At step S1540, a robot 532 unloads the workpiece from the tooling cart, at step S1542 roller flanging, laser welding and/or other operations are performed on the workpiece in the cell, and at step S1544 the finished workpiece is loaded onto one of the storage racks 560. At step S1546, the automated guided vehicle then continues along the transport path 522, returns to the home location 524, and begins the process again.

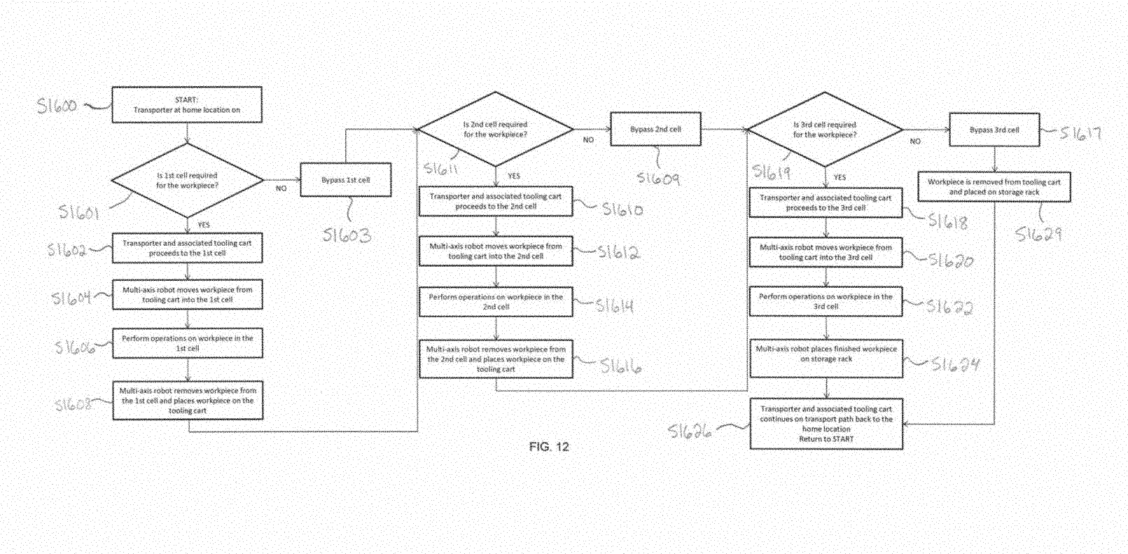

With reference to FIG. 12, a method of manufacturing vehicle body closure panels includes providing a transporter such as an automated guided vehicle on an endless transport path that defines a loop and a controller that controls the transporter along the transport path. The transporter follows the transport path along which a plurality of work cells (for example, a first cell, a second cell, and a third cell) are disposed in a sequence. The work cells may be, for example, an inner spot welding cell, an inner remote laser welding cell, and an outer roller flanging and laser welding cell. The controller causes the workpiece to be moved into and out of selected work cells, and the controller causes the workpiece to be moved past any unselected work cells. Multi-axis robots controlled by the controller move the workpiece into, out of, and within the selected work cells. The transporter begins at a location that is a home position (step S1600), and a workpiece loaded onto a tooling cart that is connected to the transporter. If the first cell is not required for the workpiece (“NO” at step S1601), the transporter bypasses the first cell at step S1603. Otherwise, if the first cell is required (“YES” at step S1601), the transporter moves along the transport path to the first cell and makes a stop at the first cell at step S1602. A multi-axis robot moves the workpiece from the tooling cart into the first cell at step S1604. Operations are then performed on the workpiece, such as, for example, inner spot welding at step S1606. When the operations in the first cell are complete, a multi-axis robot removes the workpiece from the first cell and places the workpiece back onto the tooling cart at step S1608. Next, if the second cell is not required for the workpiece (“NO” at step S1611), the transporter bypasses the second cell at step S1609. Otherwise, if the second cell is required (“YES” at step S1611), the transporter moves to the second cell and makes a stop at the second cell at step S1610. A multi-axis robot moves the workpiece from the tooling cart into the second cell at step S1612. Operations are then performed on the workpiece, such as, for example, inner remote laser welding at step S1614. When the operations in the second cell are complete, a multi-axis robot removes the workpiece from the second cell and places the workpiece back onto the tooling cart at step S1616. Next, if the third cell is not required for the workpiece at step S1619, the transporter bypasses the third cell (“NO” at step S1617). Otherwise, if the third cell is required (“YES” at step S1619), the transporter moves to the third cell and makes a stop at the third cell at step S1618. A multi-axis robot moves the workpiece from the tooling cart into the third cell at step S1620. Operations are then performed on the workpiece, such as, for example, outer roller flanging followed by laser welding at step S1622. When the operations in the third cell are complete, a multi-axis robot may place the finished workpiece onto a storage rack at step S1624. If the third cell was bypassed, the workpiece may be removed from the tooling cart and placed on a storage rack at step S1629. After the third cell, the transporter and associated tooling cart may then continue along the transport path back to the home location at step S1626 and start the process again.

Additional work cells may be added along the transport path, and the transporter may selectively transfer workpieces between original and added work cells, by selecting at least some of the work cells and making a stop at the selected work cells, and bypassing any unselected work cells. Additional equipment may also be added to the existing work cells, allowing for additional operations to be performed on a workpiece or for operations to be performed on a variety of different workpieces within the work cells.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A modular production line system comprising:
an endless transport path defining a loop;
a plurality of work cells in which forming processes are performed on a workpiece, the work cells being disposed in a sequence along the transport path;
the work cells including an inner spot welding cell, an inner remote laser welding cell, and an outer roller flanging and laser welding cell;
a transporter that follows the transport path and selectively transfers the workpiece between the work cells along the transport path; and
a controller that controls the transporter along the transport path;
wherein the transporter selects at least some of the work cells and makes a stop at the selected work cells, and the transporter bypasses any unselected work cells.

2. The modular production line system of claim 1, including an additional work cell along the transport path.

3. The modular production line system of claim 1, wherein the inner spot welding cell includes a panel fixture and a spot welding device that performs inner spot welding of workpieces on the panel fixture.

4. The modular production line system of claim 3, wherein the inner spot welding cell includes additional panel fixtures.

5. The modular production line system of claim 1, wherein the inner remote laser welding cell includes a panel, fixture and a laser welding device.

6. The modular production line system of claim 5, wherein the inner remote laser welding cell includes additional panel fixtures.

7. The modular production line system of claim 5, wherein the inner remote laser welding cell includes additional laser welding devices.

8. The modular production line system of claim 1, wherein the outer roller flanging and laser welding cell includes panel fixtures, roller flanging devices, laser welding devices, and storage racks that store finished workpieces.

9. The modular production line system of claim 8, wherein the outer roller flanging and laser welding cell includes additional panel fixtures and storage racks.

10. The modular production line system of claim 1, wherein the workpiece is a vehicle body closure panel.

11. The modular production line system of claim 1, wherein the workpiece is moved from the transporter into one of the selected work cells, and the workpiece is moved back to the transporter after being worked on in the selected work cell.

12. The modular production line system of claim 1, including a plurality of multi-axis robots each including an arm, wherein the robots move the workpiece to and from the transporter and move the workpiece within the work cells.

13. A modular production line system comprising:
an endless transport path defining a loop;
a plurality of work cells in which forming processes are performed on vehicle body closure panels, the work cells being disposed in a sequence along the transport path;
a transporter that follows the transport path and selectively transfers the workpiece between the work cells along the transport path; and
a controller that controls the transporter along the transport path;
wherein the transporter selects at least some of the work cells and makes a stop at the selected work cells, and the transporter bypasses any unselected work cells.

14. A method of manufacturing vehicle body closure panels, the method comprising the steps of:
selectively transferring a workpiece between a plurality of work cells disposed in a sequence along an endless transport path defining a loop, the work cells including an inner spot welding cell, an inner remote laser welding cell, and an outer roller flanging and laser welding cell, by providing a transporter that follows the transport path and moves the workpiece between the work cells along the transport path, and a controller that controls the transporter along the transport path, wherein the transporter selects at least some of the work cells and makes a stop at the selected work cells, and the transporter bypasses any unselected work cells; and
performing at least one of inner spot welding the workpiece in the inner spot welding cell, laser welding the workpiece in the inner remote laser welding cell, and roller flanging and laser welding the workpiece in the outer roller flanging and laser welding cell;
wherein at least some of the work cells along the transport path are selected and utilized, and any unselected work cells are bypassed.

15. The method of claim 14, wherein the controller causes the workpiece to be moved into and out of the selected work cells, and the controller causes the workpiece to be moved past any unselected work cells.

16. The method of claim 14, including multi-axis robots controlled by the controller, wherein the multi-axis robots move the workpiece into, out of, and within the selected work cells.

17. The method of claim 14, including the step of adding an additional work cell along the transport path.

18. The method of claim 14, including the step of adding additional equipment to at least one of the work cells.

19. The method of claim 14, wherein more than one type of finished part is produced from the workpieces by selectively choosing work cells among the plurality of work cells and/or by selectively choosing to utilize certain processes within the work cells.
